(19) United States
(12) Patent Application Publication
(10) Pub. No.: US 2025/0292152 A1
(43) Pub. Date: Sep. 18, 2025

(54) Systems and Methods for Culturally-Informed Content Moderation

(71) Applicant: Spotify AB, Stockholm (SE)

(72) Inventors: Konstantina PALLA, London (GB); José Luis REDONDO GARCÍA, Cáceres (ES); Alexander CHAN, Cambridge (GB)

(21) Appl. No.: 18/760,765

(22) Filed: Jul. 1, 2024

(30) Foreign Application Priority Data
Mar. 12, 2024 (GR) 20240100183

(51) Int. Cl. G06N 20/00

(52) U.S. Cl. CPC G06N 20/00

(57) ABSTRACT

A computer trains a plurality of machine learning models, each corresponding to a subset of the listenership of a media providing service. The training includes retrieving training data comprising text and corresponding to the subset of the listenership; using the training data, training the machine learning model; retrieving a second training data comprising second texts and classifications indicating whether the second texts meet moderation criteria; and using the second training data to train the machine learning model to indicate whether text meets the moderation criteria and to provide an explanation of why the machine learning model does or does not meet the moderation criteria. The computer system provides a media content item to each machine learning model and displays a predicted likelihood of the media content item meeting the one or more moderation criteria and an explanation of the predicted likelihood.

### RELATED APPLICATIONS

This application claims priority to Greek patent application No. 20240100183, filed Mar. 12, 2024, entitled “Systems and Methods for Culturally-Informed Content Moderation,” which is incorporated by reference in its entirety.

### TECHNICAL FIELD

The disclosed embodiments relate generally to content moderation of media content items, and, in particular, to a system that evaluates media items based on a plurality of culturally-informed models.

### BACKGROUND

Recent years have shown a remarkable growth in consumption of digital goods such as digital music, movies, books, and podcasts, among many others. The overwhelmingly large number of these goods often makes content moderation an extremely difficult task.

### SUMMARY

Content moderation at scale faces the challenge of considering local cultural distinctions when assessing content. While global policies aim to maintain decision-making consistency and prevent arbitrary rule enforcement, they often overlook regional variations in interpreting natural language as expressed in content. The embodiments of the present disclosure provide adaptive moderation systems through a machine-learning approach to address this issue by accommodating local comprehension nuances. In some embodiments, the system trains large language models on extensive datasets of regional or local media news and articles to create culturally-attuned models for that region or locality. These models aim to capture the nuances of communication across geographies with the goal of recognizing cultural and societal variations in what is considered offensive or otherwise unsuitable content. Furthermore, these models are used to generate explanations for instances of content violation, aiming to shed light on how policy guidelines are perceived when cultural and societal contexts change. Training on extensive media datasets successfully induces knowledge of cultural norms but also results in significant improvements in handling content violations on a regional basis. Additionally, these advancements include the ability to provide explanations that align with the specific local norms and nuances. This multifaceted success reinforces the critical role of an adaptable content moderation approach in keeping pace with the ever-evolving nature of the content it oversees.

To that end, in accordance with some embodiments, a method is performed at a computer system associated with a media-providing service having a listenership. The method includes training a plurality of machine learning models, each machine learning model of the plurality of machine learning models corresponding to a respective subset of the listenership, including, for each respective machine learning model: retrieving a respective first set of training data based on one or more selection criteria for the respective subset of the listenership, the first set of training data comprising a plurality of texts; using the respective first set of training data, training the respective machine learning model (e.g., to summarize text that is input to the respective machine learning model and/or to perform another fine-tuning task); retrieving a respective second set of training data comprising respective second texts and classifications indicating whether the respective second texts meet one or more moderation criteria; and using the second set of training data to train the respective machine learning model to indicate whether text that is input to the respective machine learning model meets the one or more moderation criteria and to provide an explanation of why the text does or does not meet the one or more moderation criteria. The method further includes providing a media content item to each machine learning model of the plurality of machine learning models; and displaying a predicted likelihood of the media content item meeting the one or more moderation criteria and an explanation of the predicted likelihood.

In accordance with some embodiments, an electronic device is provided. The electronic device includes one or more processors and memory storing one or more programs. The one or more programs include instructions for performing any of the methods described herein.

In accordance with some embodiments, a non-transitory computer-readable storage medium is provided. The non-transitory computer-readable storage medium stores one or more programs for execution by an electronic device with one or more processors. The one or more programs comprising instructions for performing any of the methods described herein.

Thus, systems are provided with improved methods for content moderation of media content items through the use of different machine-learning models (e.g., neural networks such as large language models) to generate culturally-attuned moderation results.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is a block diagram illustrating a media content delivery system, in accordance with some embodiments.

FIG. 2 is a block diagram illustrating an electronic device, in accordance with some embodiments.

FIG. 3 is a block diagram illustrating a media content server, in accordance with some embodiments.

FIG. 4 is a block diagram of a system for evaluating media items using a plurality of culturally informed models, in accordance with some embodiments.

FIGS. 5A-5C are flow diagrams illustrating a method of evaluating media items using a plurality of culturally informed models, in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first electronic device could be termed a second electronic device, and, similarly, a second electronic device could be termed a first electronic device, without departing from the scope of the various described embodiments. The first electronic device and the second electronic device are both electronic devices, but they are not the same electronic device.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As described herein, the world knowledge of a neural network is the information that the neural network has learned about the world through a corpus of generalized information (e.g., information non-specific to the media providing services described herein) that it was trained on. That is, the world knowledge includes the information explicitly provided to and inferred by the neural network before it is additionally trained for a specific context and/or purpose (e.g., by fine-tuning the neural network). In some embodiments, different content moderation models are trained on different “world knowledge,” e.g., using content that originates from a particular culture and/or geographical region. Note that the knowledge may be applicable beyond the particular culture and/or geographical region, and is still thus appropriately termed “world knowledge.” For example, one content moderation model may be at least partially trained using news articles from Malaysia, including articles describing events happening in the United States, whereas another content moderation model may be at least partially trained using news articles from the United States, describing the same events happening the United States. Each set of articles contributes to the respective models world knowledge, but in some embodiments the origin of the articles is restricted for training the separate models.

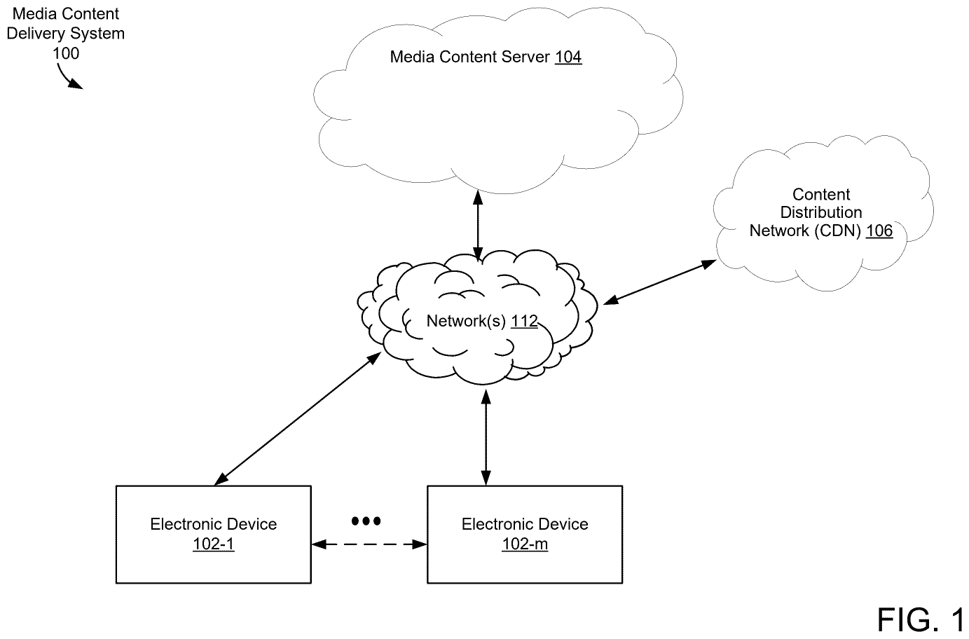

FIG. 1 is a block diagram illustrating a media content delivery system 100, in accordance with some embodiments. The media content delivery system 100 includes one or more electronic devices 102 (e.g., electronic device 102-1 to electronic device 102-m, where m is an integer greater than one), one or more media content servers 104, and/or one or more content distribution networks (CDNs) 106. The one or more media content servers 104 are associated with (e.g., at least partially compose) a media-providing service. The one or more CDNs 106 store and/or provide one or more content items (e.g., to electronic devices 102). In some embodiments, the CDNs 106 are included in the media content servers 104. One or more networks 112 communicably couple the components of the media content delivery system 100. In some embodiments, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 is a personal computer, mobile electronic device, wearable computing device, laptop computer, tablet computer, mobile phone, feature phone, smart phone, an infotainment system, digital media player, a speaker, television (TV), and/or any other electronic device capable of presenting media content (e.g., controlling playback of media items, such as music tracks, podcasts, videos, etc.). Electronic devices 102 may connect to each other wirelessly and/or through a wired connection (e.g., directly through an interface, such as an HDMI interface). In some embodiments, electronic devices 102-1 and 102-m are the same type of device (e.g., electronic device 102-1 and electronic device 102-m are both speakers). Alternatively, electronic device 102-1 and electronic device 102-m include two or more distinct types of devices.

In some embodiments, electronic devices 102-1 and 102-m send and receive media-control information through network(s) 112. For example, electronic devices 102-1 and 102-m send media control requests (e.g., requests to play music, podcasts, movies, videos, or other media items, or playlists thereof) to media content server 104 through network(s) 112. Additionally, electronic devices 102-1 and 102-m, in some embodiments, also send indications of media content items to media content server 104 through network(s) 112. In some embodiments, the media content items are uploaded to electronic devices 102-1 and 102-m before the electronic devices forward the media content items to media content server 104.

In some embodiments, electronic device 102-1 communicates directly with electronic device 102-m (e.g., as illustrated by the dotted-line arrow), or any other electronic device 102. As illustrated in FIG. 1, electronic device 102-1 is able to communicate directly (e.g., through a wired connection and/or through a short-range wireless signal, such as those associated with personal-area-network (e.g., BLUETOOTH/BLE) communication technologies, radio-frequency-based near-field communication technologies, infrared communication technologies, etc.) with electronic device 102-m. In some embodiments, electronic device 102-1 communicates with electronic device 102-m through network(s) 112. In some embodiments, electronic device 102-1 uses the direct connection with electronic device 102-m to stream content (e.g., data for media items) for playback on the electronic device 102-m.

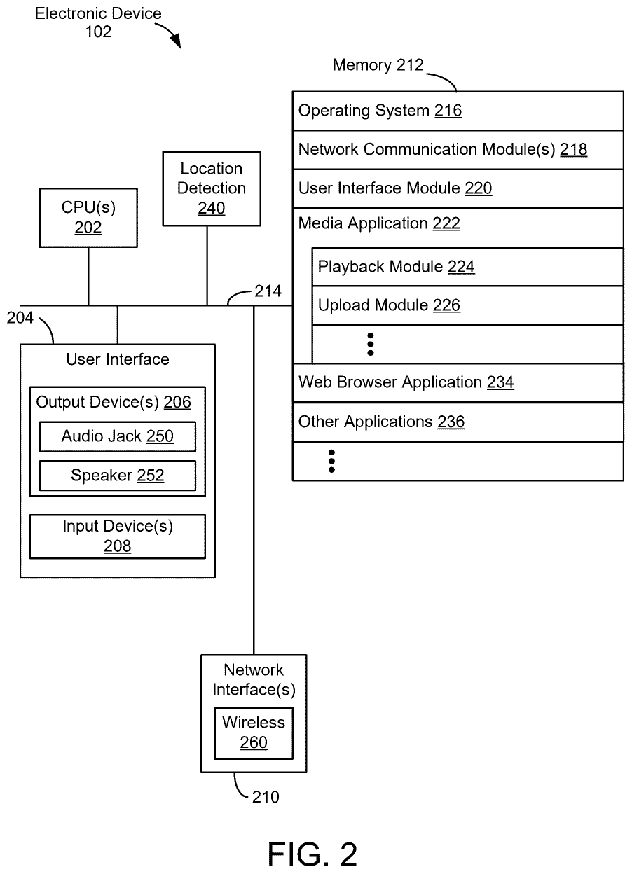

In some embodiments, electronic device 102-1 and/or electronic device 102-m include a media application 222 (FIG. 2) that allows a respective user of the respective electronic device to upload (e.g., to media content server 104), browse, request (e.g., for playback at the electronic device 102), and/or present media content (e.g., control playback of music tracks, playlists, videos, etc.). In some embodiments, one or more media content items are stored locally by an electronic device 102 (e.g., in memory 212 of the electronic device 102, FIG. 2). In some embodiments, one or more media content items are received by an electronic device 102 in a data stream (e.g., from the CDN 106 and/or from the media content server 104). The electronic device(s) 102 are capable of receiving media content (e.g., from the CDN 106) and presenting the received media content. For example, electronic device 102-1 may be a component of a network-connected audio/video system (e.g., a home entertainment system, a radio/alarm clock with a digital display, or an infotainment system of a vehicle). In some embodiments, the CDN 106 sends media content to the electronic device(s) 102.

In some embodiments, the CDN 106 stores and provides media content (e.g., media content requested by the media application 222 of electronic device 102) to electronic device 102 via the network(s) 112. Content (also referred to herein as “media items,” “media content items,” and “content items”) is received, stored, and/or served by the CDN 106. In some embodiments, content includes audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2- or 3-dimensional graphics-based computer games, etc.), or any combination of content types (e.g., web pages that include any combination of the foregoing types of content or other content not explicitly listed). In some embodiments, content includes one or more audio media items (also referred to herein as “audio items,” “tracks,” and/or “audio tracks”).

In some embodiments, media content server 104 receives media requests (e.g., commands) from electronic devices 102. In some embodiments, media content server 104 includes a voice API, a connect API, and/or key service. In some embodiments, media content server 104 validates (e.g., using key service) electronic devices 102 by exchanging one or more keys (e.g., tokens) with electronic device(s) 102.

In some embodiments, media content server 104 and/or CDN 106 stores one or more playlists (e.g., information indicating a set of media content items). For example, a playlist is a set of media content items defined by a user and/or defined by an editor associated with a media-providing service. The description of the media content server 104 as a “server” is intended as a functional description of the devices, systems, processor cores, and/or other components that provide the functionality attributed to the media content server 104. It will be understood that the media content server 104 may be a single server computer, or may be multiple server computers. Moreover, the media content server 104 may be coupled to CDN 106 and/or other servers and/or server systems, or other devices, such as other client devices, databases, content delivery networks (e.g., peer-to-peer networks), network caches, and the like. In some embodiments, the media content server 104 is implemented by multiple computing devices working together to perform the actions of a server system (e.g., cloud computing).

FIG. 2 is a block diagram illustrating an electronic device 102 (e.g., electronic device 102-1 and/or electronic device 102-m, FIG. 1), in accordance with some embodiments. The electronic device 102 includes one or more central processing units (CPU(s), i.e., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204, including output device(s) 206 and/or input device(s) 208. In some embodiments, the input devices 208 include a keyboard, mouse, or track pad. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., output device(s) 206) include a speaker 252 (e.g., speakerphone device) and/or an audio jack 250 (or other physical output connection port) for connecting to speakers, earphones, headphones, or other external listening devices. Furthermore, some electronic devices 102 use a microphone and voice recognition device to supplement or replace the keyboard. Optionally, the electronic device 102 includes an audio input device (e.g., a microphone) to capture audio (e.g., speech from a user).

Optionally, the electronic device 102 includes a location-detection device 240, such as a global navigation satellite system (GNSS) (e.g., GPS (global positioning system), GLONASS, Galileo, BeiDou) or other geo-location receiver, and/or location-detection software for determining the location of the electronic device 102 (e.g., module for finding a position of the electronic device 102 using trilateration of measured signal strengths for nearby devices).

In some embodiments, the one or more network interfaces 210 include wireless and/or wired interfaces for receiving data from and/or transmitting data to other electronic devices 102, a media content server 104, a CDN 106, and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.).

Furthermore, in some embodiments, data communications are carried out using any of a variety of custom or standard wired protocols (e.g., USB, Firewire, Ethernet, etc.). For example, the one or more network interfaces 210 include a wireless interface 260 for enabling wireless data communications with other electronic devices 102, media presentations systems, and/or or other wireless (e.g., Bluetooth-compatible) devices (e.g., for streaming audio data to the media presentations system of an automobile). Furthermore, in some embodiments, the wireless interface 260 (or a different communications interface of the one or more network interfaces 210) enables data communications with other WLAN-compatible devices (e.g., a media presentations system) and/or the media content server 104 (via the one or more network(s) 112, FIG. 1).

In some embodiments, electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the client device 102 to other computing devices (e.g., media presentation system(s), media content server 104, and/or other client devices) via the one or more network interface(s) 210 (wired or wireless) connected to one or more network(s) 112;
a user interface module 220 that receives commands and/or inputs from a user via the user interface 204 (e.g., from the input devices 208) and provides outputs for playback and/or display on the user interface 204 (e.g., the output devices 206);
a media application 222 (e.g., an application for accessing a media-providing service of a media content provider associated with media content server 104) for uploading, browsing, receiving, processing, presenting, and/or requesting playback of media (e.g., media items). In some embodiments, media application 222 includes a media player, a streaming media application, and/or any other appropriate application or component of an application. In some embodiments, media application 222 is used to monitor, store, and/or transmit (e.g., to media content server 104) data associated with user behavior. In some embodiments, media application 222 also includes the following modules (or sets of instructions), or a subset or superset thereof:
   an upload module 224 through which users or other third-parties (artists, podcasters, production companies, etc.) may upload content, which may be subject to content moderations;
   a playback module 226 for playing back media items, including media items uploaded by other users and/or other third parties;
a web browser application 234 for accessing, viewing, and interacting with web sites; and
other applications 236, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

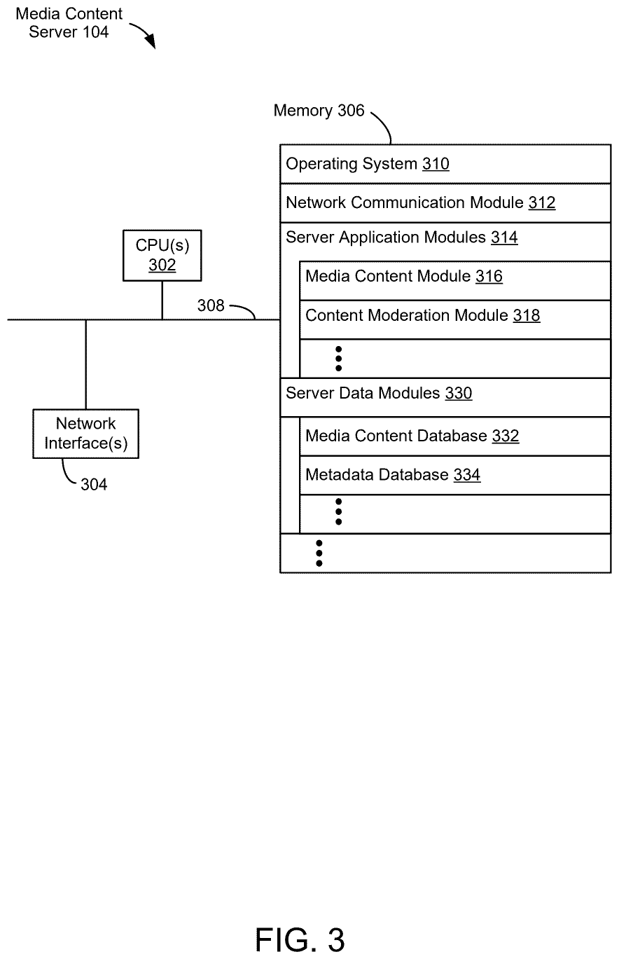

FIG. 3 is a block diagram illustrating a media content server 104, in accordance with some embodiments. The media content server 104 typically includes one or more central processing units/cores (CPUs) 302, one or more network interfaces 304, memory 306, and one or more communication buses 308 for interconnecting these components.

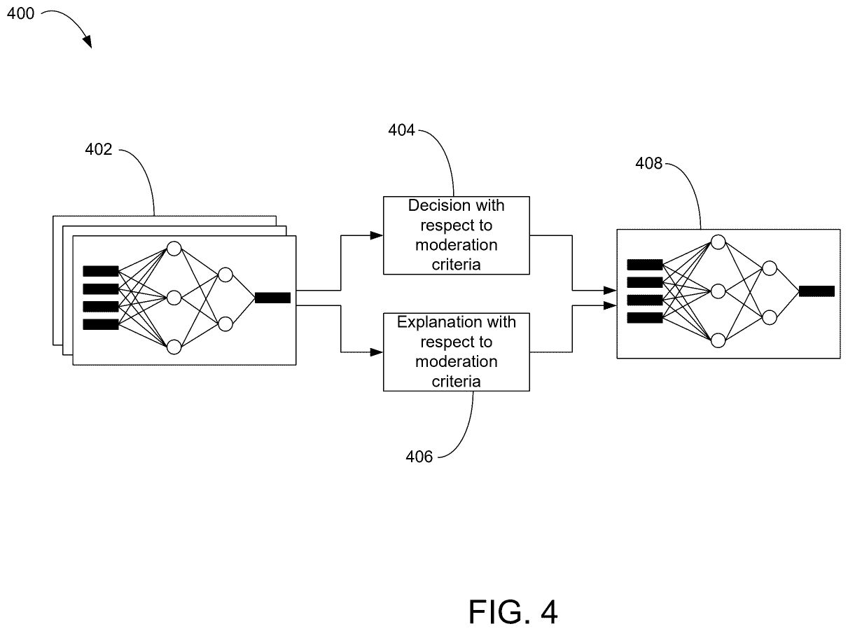

Memory 306 includes high-speed random-access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof:
an operating system 310 that includes procedures for handling various basic system services and for performing hardware-dependent tasks;
a network communication module 312 that is used for connecting the media content server 104 to other computing devices via one or more network interfaces 304 (wired or wireless) connected to one or more networks 112;
one or more server application modules 314 for performing various functions with respect to providing and managing a content service, the server application modules 314 including, but not limited to, one or more of:
   a media content module 316 for storing one or more media content items and/or sending (e.g., streaming), to the electronic device, one or more requested media content item(s);
   a content moderation module 318 for performing content moderation operations (e.g., on content uploaded by users and/or other third parties). In some embodiments, at least some of the content moderation operations performed by module 318 are performed automatically (e.g., upon upload, without user intervention). In some embodiments, at least some of the content moderation operations are performed in response to user interaction (e.g., through a chat bot provided by model 408, FIG. 4);
one or more server data module(s) 330 for handling the storage of and/or access to media items and/or metadata relating to the media items; in some embodiments, the one or more server data module(s) 330 include:
   a media content database 332 for storing media items; and
   a metadata database 334 for storing metadata relating to the media items, including a genre associated with the respective media items.

In some embodiments, the media content server 104 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous Javascript and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (i.e., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above.

Although FIG. 3 illustrates the media content server 104 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. In some embodiments, media content database 332 and/or metadata database 334 are stored on devices (e.g., CDN 106) that are accessed by media content server 104. The actual number of servers used to implement the media content server 104, and how features are allocated among them, will vary from one implementation to another and, optionally, depends in part on the amount of data traffic that the server system handles during peak usage periods as well as during average usage periods.

FIG. 4 is a block diagram of a system 400 for evaluating media items using a plurality of culturally-informed models, in accordance with some embodiments. System 400 includes a plurality of machine-learning models (e.g., large language models) 402. In some embodiments, machine learning models 402 comprise encoder-decoder language models. Each of the plurality of machine-learning models corresponds to a respective subset of listenership (e.g., is culturally informed with respect to the respective subset of listenership). For example, in some embodiments, the subsets of listenership correspond to different geographical regions (e.g., different countries, different continents). One of skill in the art, however, will appreciate that any classification of the listenership may be used, including characteristics for which the listeners have self-identified (e.g., through a user profile).

In an initial training step, each of the plurality of machine learning models 402 is separately trained using text corresponding to that subset of listenership. That is, each of the plurality of machine learning models 402 is trained using a set of training texts that meets one or more selection criteria for that subset of listenership. For example, a respective machine learning model for North America may be trained using a corpus of text (e.g., news articles, transcripts of audio, etc.) from North America (in this example, a selection criterion is that the text originated or was initially published in North America). In some embodiments, the initial training trains the machine learning model to summarize the text in the training corpus (e.g., for the machine learning model (e.g., neural network) to perform a summarization task and/or other fine-tuning task). To that end, in some embodiments, the training data for the initial training step comprise {article, summary} pairs sourced from articles that meet the one or more selection criteria (and thus form the corpus for the respective model 402). In some circumstances, the pairs are sourced from a diverse range of local news outlets specific to each region. The initial training materials thus provide world knowledge specific to that subset of the listenership (e.g., which captures nuance in the way that that subset of listenership will understand and appreciate text), as well as a basic ability to describe aspects of text that is fed into the model. Thus, in some embodiments different (e.g., distinct) corpora are used to train each of the plurality of machine learning models 402.

Note that, although the training step described above is described as an “initial training step,” in some embodiments, the initial training step is an initial fine-tuning training step. In such embodiments, prior to the initial training step above, the machine learning models are pre-trained using a general corpus of text (e.g., the same corpus of text for each of the machine learning models 402). In this sense, in some embodiments, each machine learning model 402 is an instance of the same pre-trained machine learning model, that further undergoes the initial training described above and the subsequent training described below. The initial training and subsequent training thus cause the different instances of the pre-trained model to differ slightly (e.g., have different weights), in a way that takes into account the cultural context specific to each subset of the listenership (e.g., each geographic region).

In a subsequent training step, each of the plurality of machine learning models 402 is trained on labeled second texts (e.g., which are separate and/or distinct from the first training data). In the subsequent training step, each of the plurality of machine learning models is trained to indicate (e.g., via decision 404) whether text that is input to the respective machine learning model meets one or more moderation criteria (e.g., policy content violation criteria) and to provide an explanation 406 of why the respective machine learning model does or does not meet the one or more moderation criteria. In some embodiments, the one or more moderation criteria varies across regions (e.g., different moderation criteria are applied to the different machine learning models). In some embodiments, the one or more moderation criteria does not vary across regions, but, based on the trained models, text that is considered to meet moderation criteria using one model is considered to not meet moderation criteria using another model (e.g., based on the cultural context that is imported on the trained model at the initial training step described above). To generate explanations, the encoder-decoder of the first step is fine-tuned on a sequence-to-sequence task of {content, explanation} pairs. The encoder is then employed with the weights fixed as a component of a supervised task in which a classification head is fine-tuned using {content, violation label (0/1)} pairs for the purpose of detecting content violations.

In some embodiments, the subsequent training step is a fine-tuning training step subsequent to the initial training step. For example, the world knowledge and summarization ability gained through the initial training step is adapted, via the subsequent training step, so as to configure the model to be able to perform the specific task of determining whether the moderation criteria are met and provide an explanation (e.g., an outline, digest or summary) of the reason why (for the corresponding subset of listenership). Note that the second texts are, in general, not the same texts as the first texts, and may in fact be a completely different type of text. For example, in some embodiments, the first texts comprise a corpus of news articles and the second texts comprise transcripts of podcasts and a label of violative or not violative (e.g., {0/1}) and/or an explanation of the grounds of violation (e.g., optionally provided by human annotators).

In some embodiments, a user may interact with system 400 through a chatbot, which is supported by another machine learning model (e.g., large language model 408). Through the chatbot, the user can perform operations such as: inputting text to be evaluated according to the moderation criteria, identifying a particular subset of the listenership (e.g., specific geographic area), receiving decisions 404 (e.g., which may include a probability of a content violation for the corresponding subset of listenership, where the probability is a number between 0 and 1 or a percentage between 0% and 100%) and explanation 406 in a conversational manner, asking follow-up questions, and so on. In some embodiments, rather than supplying the text to be evaluated (e.g., the transcript of a media item), a user may provide an identifier of the media item to the chatbot. The chatbot may respond by indicating that, for example, the media item passes moderation criteria for North America but may fail moderation criteria in Asia, and explain why (e.g., where the large language model 408 accesses the outputs of at least a subset of the plurality of machine learning models 402 and their associated decisions 404 and explanations 406).

In some embodiments, when a new media item is uploaded to the media-providing service, the media-providing service ingests the new media item, including automatically (without user intervention) providing a transcript (e.g., and/or other textual dimension, such as optical character recognition (OCR) or automatic speech recognition (ASR)) of the new media item to system 400. The system 400 then generates a report indicative of whether the system 400 predicts that the transcript of the new media item meets or fails any of the moderation criteria. As such, the system 400 runs predictions over the textual dimension of these media items (e.g., transcripts, outputs from OCR and/or ASR) but not directly over the audio and/or video of the media item. In some embodiments, in accordance with a determination that the new media item does not fail any of the moderation criteria (e.g., the probability of the media item violating a content policy is below a threshold) the system 400 automatically (without user intervention) approves the new media item and the media providing service streams the new media item to listeners. In some embodiments, in accordance with a determination that the new media item fails moderation criteria, the system 400 provides the new media item to secondary review (e.g., human review) and the media providing service forgoes streaming the new media item until the secondary review is complete. In some embodiments, this process is done for each subset of listenership, e.g., the new media item may be streamed to some subsets of listenership but await secondary review for others.

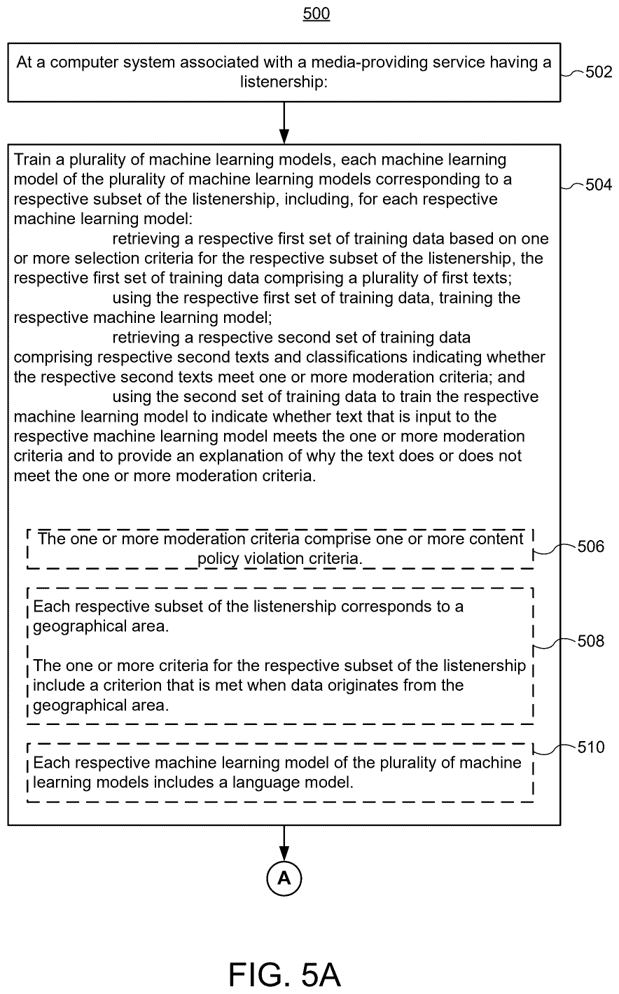

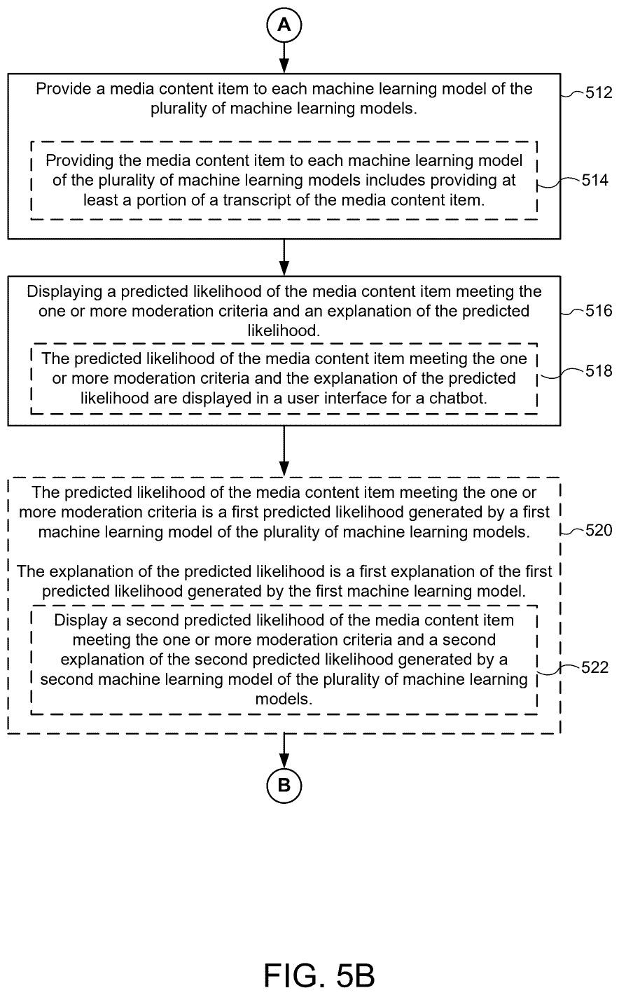

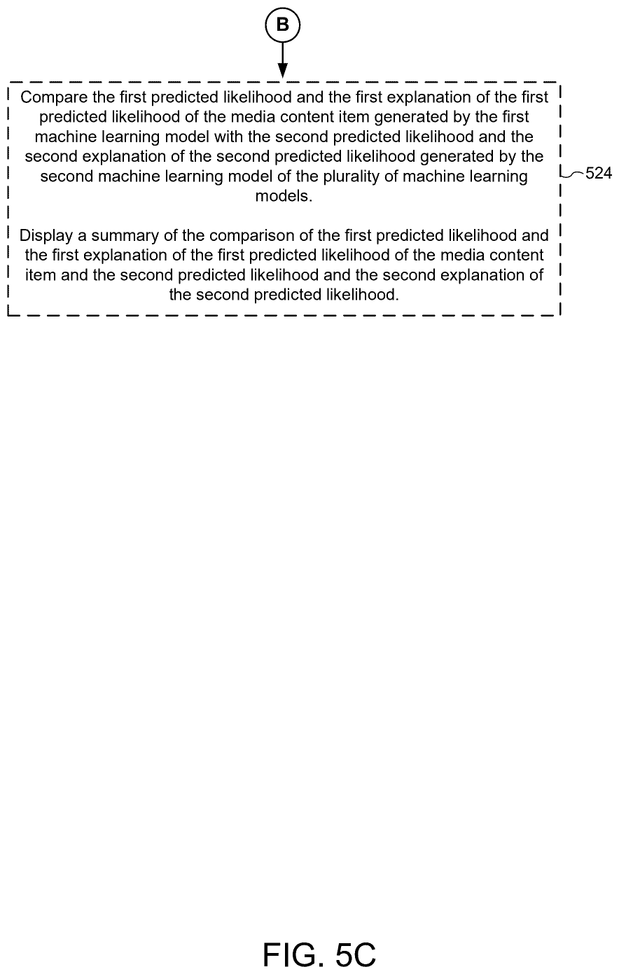

FIGS. 5A-5C are flow diagrams illustrating a method 500 of evaluating media items using a plurality of culturally informed models, in accordance with some embodiments. In some embodiments, method 500 is performed at a computer system (502) associated with a media-providing service having a listenership. For explanatory purposes, the various blocks of the method 500 are described herein with reference to FIGS. 1-4, and the associated components and/or processes described herein. Operations of the method 500 may be performed at the system 400, which may include or be a component of one or more electronic devices (e.g., electronic device 102-1, media content server 104). For example, the system 400 may be included in non-transitory computer-readable media of the content moderation module 318 of the media content server 104. In accordance with some embodiments, operations of the method 500 may be performed at multiple different devices, including client devices 102 and media content server 104.

Method 500 includes training (504) a plurality of machine learning models, e.g., according to the initial training step discussed with reference to FIG. 4. Each machine learning model of the plurality of machine learning models corresponds to a respective subset of the listenership. The training includes, for each respective machine learning model, retrieving a respective first set of training data based on one or more selection criteria for the respective subset of the listenership, the first set of training data comprising a plurality of first texts. In some embodiments, the first set of training data is unsupervised data, such as text from a particular region associated with a subset, less than all, of the listenership. In some embodiments, each respective first set of training data is a local corpus of a plurality of local corpora, each corresponding to a different geographical region or other cultural region(s). In some embodiments, training step 504 includes fine-tuning a plurality of instances of a pre-trained language model. In some embodiments, the language model is an encoder-decoder model.

The training of each respective machine learning model further includes using the respective first set of training data, training the respective machine learning model to summarize text and/or perform another fine-tuning task that is input to the respective machine learning model. To that end, in some embodiments, the training data for the training step 504 comprise {article, summary} pairs sourced from articles that meet the one or more selection criteria. In some embodiments, another fine-tuning task (e.g., other than summarization) is performed in order for the model to learn knowledge of a respective culture. For example, the fine-tuning task includes applying make language modeling on {articles}.

The training of each respective machine learning model further includes retrieving a respective second set of training data comprising respective second texts (e.g., each text associated with a media content item) and classifications indicating whether the respective second texts (e.g., for a respective media content item) meet one or more moderation criteria (e.g., {media content item, violation label (0/1)} pairs, as well, as optionally {media content item, explanation} pairs).

The training of each respective machine learning model further includes using the second set of training data to train the respective machine learning model to indicate whether text that is input to the respective machine learning model meets the one or more moderation criteria (e.g., using the {content, violation label (0/1)} pairs), and to provide an explanation of why the text does or does not meet the one or more moderation criteria (e.g., using the {content, explanation} pairs).

In some embodiments, the one or more moderation criteria are (506) content policy violation criteria. In some embodiments, the content policy violation criteria include hate speech, discrimination, and/or disinformation criteria.

In some embodiments, each respective subset of the listenership corresponds (508) to a geographical area (e.g., and/or otherwise defined cultural area(s)). The one or more selection criteria for the respective subset of the listenership include a criterion that is met when data originates from the geographical area.

In some embodiments each machine learning model includes (510) a language model (e.g., an example of a neural network). A neural network is a type of machine-learning model that is capable of performing various natural-language processing tasks. Some neural networks, such as large-language models (LLMs), leverage so-called “world knowledge” obtained by training the neural networks on large corpuses of non-specific training data. Although the neural networks are trained with non-specific training data, they learn about general patterns in text, which can be used to analyze, e.g., input text in terms of concepts and sentiments that are present in the training models.

Method 500 further includes providing (512) a media content item to each machine learning model of the plurality of machine learning models. In some embodiments, the media content item is provided to a single machine learning model of the plurality of machine learning models (e.g., as directed by a user interacting with a chatbot, as described with reference to FIG. 4. For example, a user may ask the chatbot “Does this media content item violate any policies in Australia?”).

In some embodiments, providing the media content item to each machine learning model of the plurality of machine learning models includes (514) providing at least a portion of a transcript of the media content item.

Method 500 further includes displaying (516) a predicted likelihood of the media content item meeting the one or more moderation criteria and an explanation of the predicted likelihood.

In some embodiments, the predicted likelihood of the media content item meeting the one or more moderation criteria and the explanation of the predicted likelihood are displayed (518) in a user interface for a chatbot.

In some embodiments, the predicted likelihood of the media content item meeting the one or more moderation criteria is (520) a first predicted likelihood generated by a first machine learning model of the plurality of machine learning models. In some embodiments, the explanation of the predicted likelihood is a first explanation of the first predicted likelihood generated by the first machine learning model. In some embodiments, method 500 includes displaying (522) a second predicted likelihood of the media content item meeting the one or more moderation criteria and a second explanation of the second predicted likelihood generated by a second machine learning model of the plurality of machine learning models.

In some embodiments, method 500 further includes comparing (524) the first predicted likelihood and the first explanation of the first predicted likelihood of the media content item generated by the first machine learning model with the second predicted likelihood and the second explanation of the second predicted likelihood generated by the second machine learning model of the plurality of machine learning models. In some embodiments, method 500 further includes displaying (e.g., in a user interface of an application of the media-providing service and/or in a user interface for a chatbot) a summary of the comparison of the first predicted likelihood and the first explanation of the first predicted likelihood of the media content item and the second predicted likelihood and the second explanation of the second predicted likelihood.

Although FIGS. 5A-5C illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A method, comprising:
at a computer system associated with a media-providing service having a listenership:
training a plurality of machine learning models, each machine learning model of the plurality of machine learning models corresponding to a respective subset of the listenership, including, for each respective machine learning model:
retrieving a respective first set of training data based on one or more selection criteria for the respective subset of the listenership, the respective first set of training data comprising a plurality of first texts;
using the respective first set of training data, training the respective machine learning model;
retrieving a respective second set of training data comprising (i) respective second texts and (ii) classifications indicating whether the respective second texts meet one or more moderation criteria; and
using the second set of training data to train the respective machine learning model to indicate whether text that is input to the respective machine learning model meets the one or more moderation criteria and to provide an explanation of why the text does or does not meet the one or more moderation criteria;
providing a media content item to each machine learning model of the plurality of machine learning models; and
displaying a predicted likelihood of the media content item meeting the one or more moderation criteria and an explanation of the predicted likelihood.

2. The method of claim 1, wherein the one or more moderation criteria comprise one or more content policy violation criteria.

3. The method of claim 1, wherein:
the predicted likelihood of the media content item meeting the one or more moderation criteria is a first predicted likelihood generated by a first machine learning model of the plurality of machine learning models;
the explanation of the predicted likelihood is a first explanation of the first predicted likelihood generated by the first machine learning model; and
the method further includes:
displaying a second predicted likelihood of the media content item meeting the one or more moderation criteria and a second explanation of the second predicted likelihood generated by a second machine learning model of the plurality of machine learning models.

4. The method of claim 3, further including:
comparing the first predicted likelihood and the first explanation of the first predicted likelihood of the media content item generated by the first machine learning model with the second predicted likelihood and the second explanation of the second predicted likelihood generated by the second machine learning model of the plurality of machine learning models; and
displaying a summary of the comparison of the first predicted likelihood and the first explanation of the first predicted likelihood of the media content item and the second predicted likelihood and the second explanation of the second predicted likelihood.

5. The method of claim 1, wherein:
each respective subset of the listenership corresponds to a geographical area; and
the one or more selection criteria for the respective subset of the listenership include a criterion that is met when data originates from the geographical area.

6. The method of claim 1, wherein providing the media content item to each machine learning model of the plurality of machine learning models includes providing at least a portion of a transcript of the media content item.

7. The method of claim 1, wherein the predicted likelihood of the media content item meeting the one or more moderation criteria and the explanation of the predicted likelihood are displayed in a user interface for a chatbot.

8. The method of claim 1, wherein each respective machine learning model of the plurality of machine learning models includes a language model.

9. A computer system associated with a media-providing service having a listenership, comprising:
one or more processors; and
memory storing one or more programs for execution by the one or more processors, the one or more programs comprising instructions for:
training a plurality of machine learning models, each machine learning model of the plurality of machine learning models corresponding to a respective subset of the listenership, including, for each respective machine learning model:
retrieving a respective first set of training data based on one or more selection criteria for the respective subset of the listenership, the respective first set of training data comprising a plurality of texts;
using the respective first set of training data, training the respective machine learning model;
retrieving a respective second set of training data comprising (i) respective second texts and (ii) classifications indicating whether the respective second texts meet one or more moderation criteria; and
using the second set of training data to train the respective machine learning model to indicate whether text that is input to the respective machine learning model meets the one or more moderation criteria and to provide an explanation of why the text does or does not meet the one or more moderation criteria;
providing a media content item to each machine learning model of the plurality of machine learning models; and
displaying a predicted likelihood of the media content item meeting the one or more moderation criteria and an explanation of the predicted likelihood.

10. The computer system of claim 9, wherein the one or more moderation criteria comprise one or more content policy violation criteria.

11. The computer system of claim 9, wherein:
the predicted likelihood of the media content item meeting the one or more moderation criteria is a first predicted likelihood generated by a first machine learning model of the plurality of machine learning models;
the explanation of the predicted likelihood is a first explanation of the first predicted likelihood generated by the first machine learning model; and
the one or more programs further comprise instructions for:
displaying a second predicted likelihood of the media content item meeting the one or more moderation criteria and a second explanation of the second predicted likelihood generated by a second machine learning model of the plurality of machine learning models.

12. The computer system of claim 11, wherein the one or more programs further comprise instructions for:
comparing the first predicted likelihood and the first explanation of the first predicted likelihood of the media content item generated by the first machine learning model with the second predicted likelihood and the second explanation of the second predicted likelihood generated by the second machine learning model of the plurality of machine learning models; and
displaying a summary of the comparison of the first predicted likelihood and the first explanation of the first predicted likelihood of the media content item and the second predicted likelihood and the second explanation of the second predicted likelihood.

13. The computer system of claim 9, wherein:
each respective subset of the listenership corresponds to a geographical area; and
the one or more selection criteria for the respective subset of the listenership include a criterion that is met when data originates from the geographical area.

14. The computer system of claim 9, wherein providing the media content item to each machine learning model of the plurality of machine learning models includes providing at least a portion of a transcript of the media content item.

15. The computer system of claim 9, wherein the predicted likelihood of the media content item meeting the one or more moderation criteria and the explanation of the predicted likelihood are displayed in a user interface for a chatbot.

16. The computer system of claim 9, wherein each respective machine learning model of the plurality of machine learning models includes a language model.

17. A non-transitory computer-readable storage medium storing one or more programs configured for execution by a computer system associated with a media-providing service having a listenership, the one or more programs comprising instructions for:
training a plurality of machine learning models, each machine learning model of the plurality of machine learning models corresponding to a respective subset of the listenership, including, for each respective machine learning model:
retrieving a respective first set of training data based on one or more section criteria for the respective subset of the listenership, the respective first set of training data comprising a plurality of texts;
using the respective first set of training data, training the respective machine learning model;
retrieving a respective second set of training data comprising (i) respective second texts and (ii) classifications indicating whether the respective second texts meet one or more moderation criteria; and
using the second set of training data to train the respective machine learning model to indicate whether text that is input to the respective machine learning model meets the one or more moderation criteria and to provide an explanation of why the text does or does not meet the one or more moderation criteria;
providing a media content item to each machine learning model of the plurality of machine learning models; and
displaying a predicted likelihood of the media content item meeting the one or more moderation criteria and an explanation of the predicted likelihood.

18. The non-transitory computer-readable storage medium of claim 17, wherein the one or more moderation criteria comprise one or more content policy violation criteria.

19. The non-transitory computer-readable storage medium of claim 17, wherein:
the predicted likelihood of the media content item meeting the one or more moderation criteria is a first predicted likelihood generated by a first machine learning model of the plurality of machine learning models;
the explanation of the predicted likelihood is a first explanation of the first predicted likelihood generated by the first machine learning model; and
the one or more programs further comprise instructions for:
displaying a second predicted likelihood of the media content item meeting the one or more moderation criteria and a second explanation of the second predicted likelihood generated by a second machine learning model of the plurality of machine learning models.

20. The non-transitory computer-readable storage medium of claim 19, wherein the one or more programs further comprise instructions for:
comparing the first predicted likelihood and the first explanation of the first predicted likelihood of the media content item generated by the first machine learning model with the second predicted likelihood and the second explanation of the second predicted likelihood generated by the second machine learning model of the plurality of machine learning models; and
displaying a summary of the comparison of the first predicted likelihood and the first explanation of the first predicted likelihood of the media content item and the second predicted likelihood and the second explanation of the second predicted likelihood.
